(19) United States
(12) Patent Application Publication
(10) Pub. No.: US 2025/0224078 A1
(43) Pub. Date: Jul. 10, 2025

(54) DEMOUNTABLE AERONAUTICAL LIQUEFIED GAS STORAGE DEVICE

(71) Applicant: ARESIA-VILLENEUVE, Villeneuve La Garenne (FR)

(72) Inventors: Xavier SUTTER, Villeneuve La Garenne (FR); Jean-Christophe BERTOLO, Villeneuve La Garenne (FR); Pascal LEGRAND, Villeneuve La Garenne (FR); Florin-Calin PAUN, Villeneuve La Garenne (FR); Nicolas WALKER, Villeneuve La Garenne (FR)

(21) Appl. No.: 18/853,777

(22) PCT Filed: Apr. 4, 2023
(86) PCT No.: PCT/FR2023/050478

§ 371 Date: Oct. 3, 2024

(30) Foreign Application Priority Data
Apr. 14, 2022 (FR) FR2203468

(51) Int. Cl. F17C 3/04

(52) U.S. Cl. CPC F17C 3/04; F17C 2201/0109; F17C 2203/0304; F17C 2203/0629; F17C 2205/0107; F17C 2205/0323; F17C 2221/011; F17C 2221/012; F17C 2221/018; F17C 2221/033; F17C 2223/0161; F17C 2250/0447; F17C 2270/0189

(57) ABSTRACT

An acronautical gas storage cryogenic tank device, comprising an inner container (26) defining a liquefied gas storage chamber (28), an outer envelope (27) containing the inner container (26) and made of a plurality of demountable parts for accessing the inner container (26), the outer envelope (27) being made of a material resistant to temperatures from less than −60° C. to at least +80° C. an insulation chamber (29) defined between the inner container (26) and the outer envelope (27), the reduced-pressure insulation chamber (29) having helium-tightness equal to or better than 10*9) millibar*litre/second defined between the inner container (26) and the outer envelope (27), two connections of which at least one is a sliding connection, supporting the inner container (26) and borne by the outer envelope (27), a removable collector (42) passing through the outer envelope (27) and the inner container (26) in a sealed manner, and a flexible thermally insulating neck (42) forming a sealed interface between the collector on the one hand and, on the other hand, the outer envelope (27) and the inner container (26), the neck (42) being formed around a portion of the collector (38), the neck (42) passing through the insulation chamber (29) in order to allow the collector (38) to be demounted independently of the pressure in the insulation chamber (29).

The present invention relates to the aeronautics field.

From its beginnings, aeronautics has employed high octane index petrol engines. After 1945, the development of the jet and the turbine led to the use of kerosene, the molecular mass of which is higher than that of petrol and the flammability of which is lower. The storage of these fuels is in tanks located in the wings, in the fuselage-wing link or in the tail.

The trend towards the reduction of carbon gas emissions has led to engines consuming less. However, the gains on emissions of carbon dioxide dwindle as certain technologies reach maturity, notably the end velocity of the blades of the vanes. It has become more and more desirable to introduce a rupture.

Thus, gas powered airplane projects have appeared. The combustion of short or non-existent carbon chain gas, if appropriate with oxygen, is not very polluting or is non-polluting. Conversely, the storage of H2, O2 or C1 or C2 gas is difficult on account of the small size of the gas molecule and subject to leakage risks.

On the ground, the conservation of such gases is generally carried out in envelopes under too heavy pressure, too voluminous and containing too much potential pressure energy to be carried on board an aircraft or in welded and/or bonded cryogenic tanks. The cryogenic conservation of such gases is restricted to a limited duration proportional to the stored volume.

Furthermore, hydrogen, methane, ethane, ethylene, acetylene or oxygen stored in the liquid state cannot be used in an internal or external combustion engine or fuel cell. The final consumption necessitates a gas state.

The need has appeared to store propellant gas within an aircraft for its consumption on board while implementing aeronautical maintenance know-how and avoiding the need for new standardisation. Indeed, the drawing up of new standards is a long and time consuming process, hence a risk of generating delays in the commercialisation of gas powered airplanes. The acquisition of new maintenance know-how is also long, costly, or may even create reticence.

The invention proposes an on-board aeronautical gas storage cryogenic tank device, of spherical or elongated shape, comprising an inner container defining a liquefied gas storage chamber, an outer envelope containing the inner container and made of a plurality of demountable parts making it possible to access the inner container, the outer envelope being made of a material resistant to temperatures from less than −60° C. to at least +80° C., an insulation chamber defined between the inner container and the outer envelope, the reduced-pressure insulation chamber having helium-tightness equal to or better than 10⁻⁹ millibar*litre/second defined between the inner container and the outer envelope, two connections of which at least one is a sliding connection, supporting the inner container and borne by the outer envelope, a removable collector passing through the outer envelope and the inner container in a sealed manner, and a flexible thermally insulating neck forming a sealed interface between the collector on the one hand and, on the other hand, the outer envelope and the inner container. The neck is formed around a portion of the collector. The neck passes through the insulation chamber in order to allow the collector to be demounted independently of the pressure in the insulation chamber. Thanks to the invention, the cryogenic tank meets the requirements, notably thermal, of aeronautical practices, notably in terms of mechanical deformation, and the bulk of ducts.

In one embodiment, the device comprises a thermally insulating stopper assembly removably mounted on the collector and accessible from the outside. The thermal insulation is satisfactory.

In one embodiment, one of the connections comprises an axial concavity in the outer envelope receiving and supporting an axial projection of the inner container. The connected is suited to the expansions likely to occur.

In one embodiment, the outer envelope comprises a frame, sealed panels, seals resistant to the pressure between the frame and the panels and/or between the panels. Maintenance is facilitated.

In one embodiment, the frame comprises ribs and spars. The construction is robust.

In one embodiment, the seals are housed in grooves and, in the free state, go beyond the grooves by a height less than 10% of a height of said seals. The leak tightness is high level.

In one embodiment, the device comprises an anti-oscillatory member inside the inner container. The mechanical behaviour, notably the stability, of the device is improved.

In one embodiment, the device comprises a stiffener inside the inner container, preferably a brace or a tie rod. The device, notably the inner container, may be lightened.

In one embodiment, the device comprising at least one support ring mounted between the inner container and the outer envelope at a distance from the connections in the insulation chamber. The rigidity is increased.

In one embodiment, a hydrogen absorbent material is arranged in the insulation chamber. A low pressure is maintained in the insulation chamber.

In one embodiment, a hydrogen presence detector is installed in the insulation chamber. Exceeding a limit value may be the subject of an alarm.

In one embodiment, an assembly comprises a device as above, a temporary storage tank forming a gasification member for the pressurisation of the gas supplied by the device, an upstream valve provided to be open for liquid flow during a phase of filling the temporary storage tank and closed outside of the filling phase, a downstream valve being provided to be open for gas flow during a phase of emptying the temporary storage tank and closed outside of the emptying phase, the upstream valve and the downstream valve being closed during a gasification phase, the upstream valve and the downstream valve being all-or-nothing commanded, and a compressor arranged downstream of the downstream valve, said compressor being active at the end of the emptying phase to bring the pressure in the temporary storage tank to a value lower than the value of the pressure in the device, and a pressure reducer arranged downstream of the downstream valve, said pressure reducer being active at the start of the emptying phase to bring the pressure of the gas at the outlet to a value lower than the pressure in the temporary storage tank. The device ensures that the aircraft, by the volume contained in the temporary tanks(s), has a necessary autonomy independent of the state of the device. The temporary tanks may be provided for a gas pressure of several hundreds of bars, a chosen gas pressure being nevertheless supplied to the consuming members. The valves are reliable. The temporary tank may be emptied sufficiently in such a way as to increase the amount of gas available for the consuming members and bring the temporary tank to a pressure at the end of emptying lower than the current pressure in the device. The filling of the temporary tank is performed by manoeuvring the cryogenic valve under the effect of pressure difference. Doing without a cryogenic pump enables a mass gain and a reduction in the risk of an incident.

In one embodiment, the temporary storage tank is provided for a service pressure greater than 500 bars.

In one embodiment, the device is provided for a service pressure lower than 8 bars.

Other features and advantages of the invention will become clear on examining the detailed description hereafter, and the appended drawings, in which:

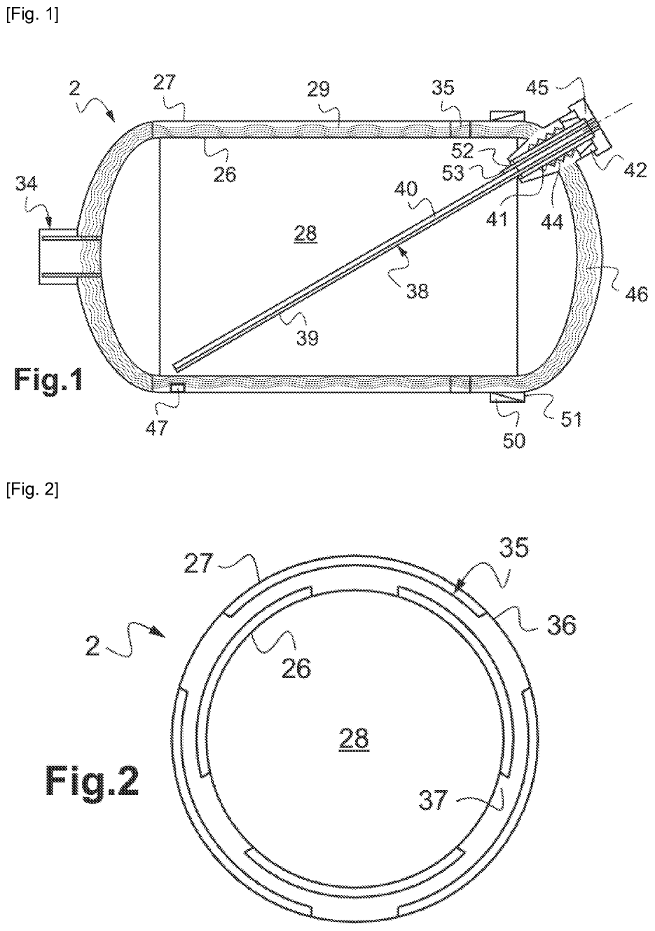

FIG. 1 schematically illustrates in axial section a device according to one aspect of the invention.

FIG. 2 schematically illustrates in transversal section a device according to one aspect of the invention.

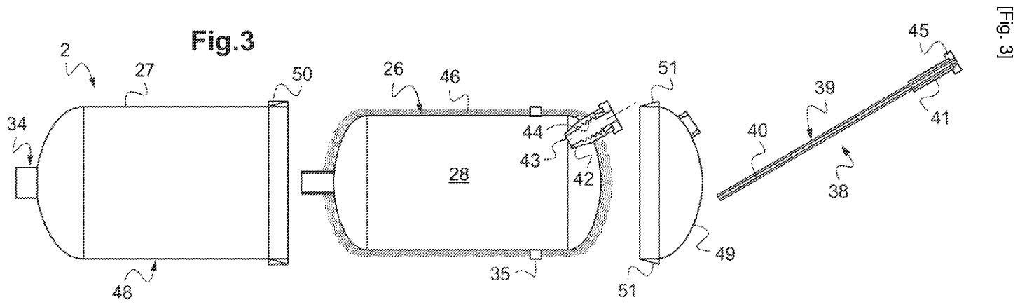

FIG. 3 schematically illustrates in side view a demounted device according to one aspect of the invention.

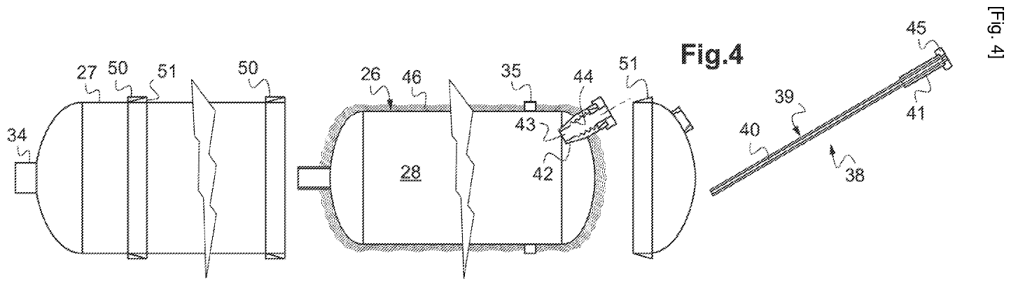

FIG. 4 schematically illustrates in side view a demounted device according to another aspect of the invention.

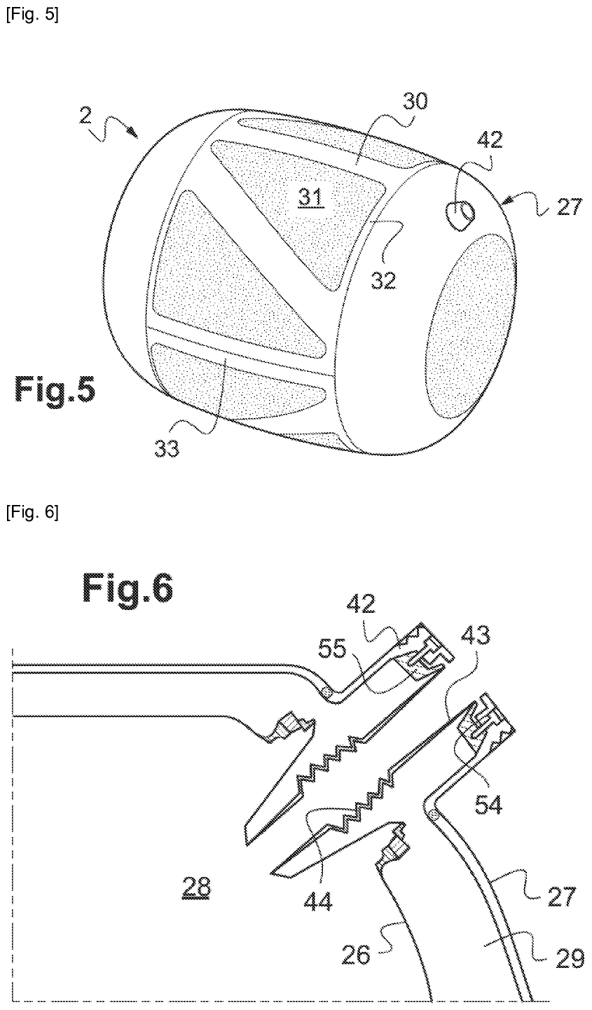

FIG. 5 schematically illustrates in perspective a device according to another aspect of the invention.

FIG. 6 schematically illustrates in section a neck according to one aspect of the invention.

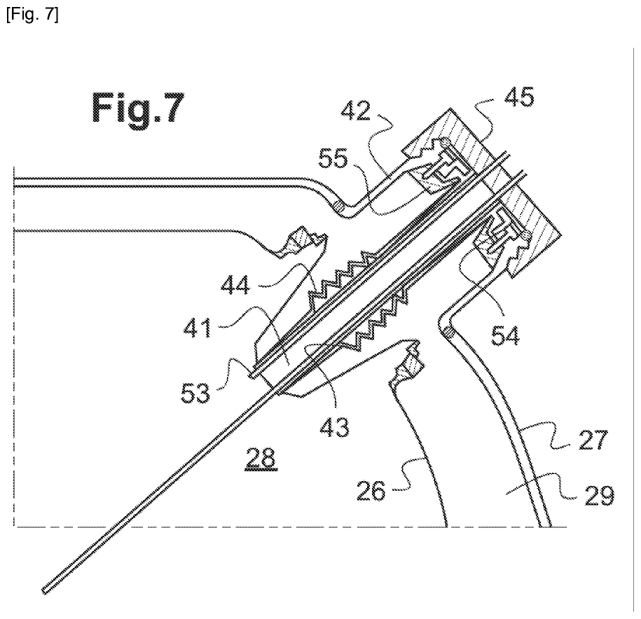

FIG. 7 schematically illustrates in section a neck and a collector according to one aspect of the invention.

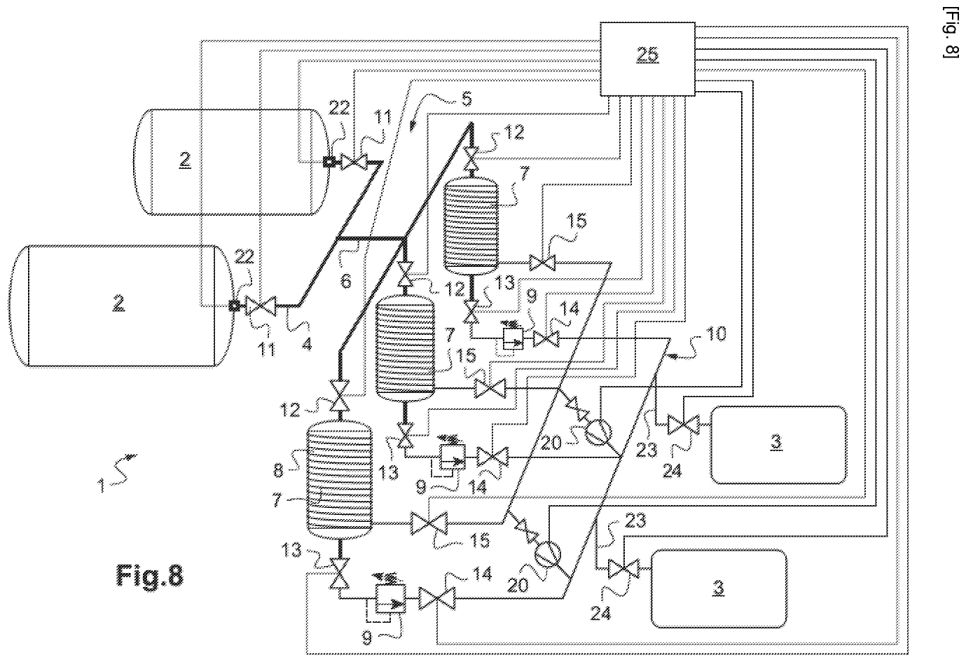

FIG. 8 schematically illustrates in perspective an assembly according to one aspect of the invention.

The appended drawings will not only be able to serve to complete the invention, but also contribute to its definition, if required.

The aeronautical gas storage device is designed to be carried on-board an aircraft: airplane, drone, helicopter, etc. The aeronautical gas storage device contains liquid and supplies gas. In other words, the gas is stored at very low temperature in liquid form in a cryogenic tank. A cryogenic tank is unsuited to withstanding high pressures, notably greater than 10 bars.

The stored gas is selected from hydrogen, methane, ethane, ethylene, acetylene and oxygen.

The Applicant also intends to take into account that gasification is a rapid phenomenon even in an ambient atmosphere at −55° C. encountered at altitude. As an embodiment, gaseous hydrogen at 0° C. and 1 atmosphere is of density around 800 times lower than liquid hydrogen at −253° C., thus of volume around 800 times greater.

Yet aeronautical maintenance rules impose being able to demount and repair or replace most of the parts of the airplane. Thus, an aircraft is capable of landing in any place—aerodrome for an airplane, landing area for a helicopter—suited to its mass and its requirements for the landing but not provided with maintenance equipment specific to the aircraft model. In the event of detected damage, the aircraft is configured to be repaired, in a long lasting or provisional manner, or demounted so as to replace or repair a defective component, in accordance with the manufacturer's manuals and documents accredited by the air safety authorities. It is desirable that the component is easily accessible by a maintenance operator. In the event of replacement, it is desirable that the component is as small as possible for easy handling and conveyance. In the event of repair, it is desirable that the component is repairable by tools and methods proven and current in the aeronautical field.

An aircraft is subject to daily, weekly, etc. inspection visits, immobilising the aircraft for a duration inversely proportional to the frequency.

Yet, gas tanks of the terrestrial industrial field or the space field are not subject to such requirements, notably are not designed for such repairability.

The Applicant has identified a need for storage, notably of hydrogen, methane, ethane, ethylene, acetylene or oxygen, from aeronautical cryogenic tanks borne by the aircraft.

The Applicant has identified a need for demountable aeronautical cryogenic tanks, inspectable according to aircraft inspection modes and repairable. Further, a tank is sought for which the useful volume/external volume ratio is high, of which the mass of contained gas/total mass ratio is high, of high reliability and high safety.

As illustrated in the figures, the aeronautical gas storage device has a generally elongated shape with rounded ends. The aeronautical gas storage device may be of annular shape around a longitudinal axis. The aeronautical gas storage device comprises an outer envelope and an inner container. The inner container forms a liquid gas storage chamber. The inner container is contained within the outer envelope. Generally, the inner container and the outer envelope are distant from each other.

In the embodiment represented, the aeronautical gas storage device has a cylindrical revolution central part and hemispherical ends. However, shapes having exceptions to cylindricity, annularity and/or hemisphericity may be manufactured.

Each cryogenic tank is insulated to contain liquid fuel or oxidant at −253° C. Each cryogenic tank is capable of withstanding a maximum service pressure of the order of 6 to 10 bars.

In the embodiment illustrated in FIGS. 1 to 3, the cryogenic tank 2 has an elongated shape, notably around an axis. The cryogenic tank 2 has domed ends and a globally cylindrical revolution central part. In an alternative, the cryogenic tank 2 has a spherical shape.

The cryogenic tank 2 comprises an inner container 26 and an outer envelope 27. The inner container 26 defines a liquified gas storage chamber 28 to contain a loading of gas at liquefaction temperature and an evaporated gas ceiling. The inner container 26 is sealed. The inner container 26 is capable of withstanding a liquefaction temperature, for example −253° C. for hydrogen. The outer envelope 27 contains the inner container 26. The outer envelope 27 is made of a plurality of demountable parts making it possible to access the inner container 26. The outer envelope 27 protects the inner container 26 against shocks. The outer envelope 27 ensures the structural strength of the aeronautical gas storage device. The outer envelope 27 is made of material resistant to temperatures from less than −60° C. to at least +80° C.

Between the inner container 26 and the outer envelope 27 is defined an insulation chamber 29. The insulation in the insulation chamber 29 is ensured by a reduced pressure compared to atmospheric pressure. Further, a solid insulating material may be arranged in the insulation chamber 29. The reduced-pressure insulation chamber 29 having helium-tightness equal to or better than 10⁻⁹ millibar*litre/second defined between the inner container 26 and the outer envelope 27. The leak tightness of the insulation chamber 29 encompasses the leak tightness with respect to the inside of the inner container 26 and the leak tightness with respect to the external atmosphere.

The inner container 26 may be made of welded metal alloy. One example of metal alloy may be Al—Cu—Li notably 2050 or 2099, Al—Cu notably 2219, stainless steel notably 304, 304L, 316, 316L. The inner container 26 has an elongated shape with two domed ends surrounding a body. The body may be cylindrical. The body may be a body of revolution.

The outer envelope 27 comprises a frame 30, sealed panels 31, seals resistant to the pressure between the frame 30 and the panels 31 and/or between the panels 31. The panels 31 may be assembled to the frame 30 by screwing.

The frame 30 comprises ribs 32 and spars 33. The ribs 32 may have a closed contour, for example annular. The spars 33 extend longitudinally. The spars 33 join together at the ends of the outer envelope 27.

The panels 31 are made of welded metal alloy or of composite materials. An example of composite materials may be epoxy resin with carbon fibres, Kevlar fibres and/or glass fibres. An example of metal alloy may be Al—Mg notably 5086, Al—Mg—Si notably 6061, Al—Cu—Li notably 2195.

Between the panels 31 and the frame 30 are provided seals. The seals may be metal/metal or synthetic material, for example elastomer. In the case of seals of synthetic material, grooves are made in the panels 31 or in the frame 30 to house said seals. In the free state, the seals go beyond the grooves by a height less than 10% of a height of said seals. Height means the diameter for an O-ring.

The cryogenic tank 2 comprises two connections between the outer envelope 27 and the inner container 26 to support the inner container 26. The connections are configured for very low thermal conduction.

At least one of the connections is a sliding connection making it possible to accommodate the differential expansion of the outer envelope 27 and the inner container 26. The connections are borne by the outer envelope 27. A first of the connections is extremal. The extremal connection 34 may comprise a central projection at one end of the inner container 26 cooperating with an axial concavity of the outer envelope 27 forming a housing for the protuberance with axial sliding over a travel of several millimetres in such a way that the contraction of the inner container 26 on filling by a liquefied gas and the expansion of the inner container 26 after emptying of the liquefied gas is free. The extremal connection 34 is configured to have a thermal conduction path of long length.

The second connection is located at a distance from the opposite end of the first connection. The second connection surrounds the inner container 26. The second connection is mounted in the insulation chamber 29. The second connection comprises a support ring 35. The support ring 35 is mounted between the inner container 26 and the outer envelope 27. The support ring 35 is mounted at a distance from the connections in the insulation chamber 29.

The support ring 35 comprises outer sectors 36 radially projecting outwards. The outer sectors 36 are here three in number. The outer sectors 36 have a peripheral surface in contact with the boring of the outer envelope 27. The outer sectors 36 occupy an angle of the order of 15 to 40°.

The support ring 35 comprises inner sectors 37 radially projecting inwards. The inner sectors 37 are here three in number. The inner sectors 37 have a convex surface in contact with the periphery of the inner container 26. The inner sectors 37 occupy an angle of the order of 15 to 40°. The outer sectors 36 and the inner sectors 37 are alternating. The outer sectors 36 and the inner sectors 37 are angularly distant from each other. Preferably, three inner sectors 37 and three outer sectors 36 of around 20 to 30° are alternately distributed and separated by zones exempt of projection and occupying an angle of around 40 to 30° respectively. The support ring 35 is maintained by a sufficient friction against the inner container 26 or by permanent fastening.

The support ring 35 is made of composite material with low thermal conduction and high mechanical strength.

The cryogenic tank 2 comprises a removable collector 38 passing through the outer envelope 27 and the inner container 26 in a sealed manner. The collector 38 comprises a straight rod 39 for withdrawal of liquefied gas in the inner container 26. The rod 39 is made of insulating material. The collector 38 comprises a first open end inside the inner container 26. The collector 38 comprises a second open end outside the outer envelope 27. The second end is provided to be connected to a duct for example an outlet duct 4, cf. FIG. 6. The first and second ends are connected by a port. The first end, in the mounted state, is located near to the lower part of the inner container 26. The first end is free. Thus, the collector 38 extracts the liquefied gas. The extraction is stopped when the liquid level is low. In other words, the inner container 26, in operation, contains a gas phase and a liquid phase. At the end of filling, the liquid phase is maximal and the gas phase is at a minimum. At the end of extraction, the liquid phase is at a minimum, or even absent, and the gas phase is maximal. The liquid phase is extracted. The extraction of the liquid phase with respect to the gas phase enables ducts of significantly smaller diameter. The compactness of the members downstream of the cryogenic tank 2 is improved. The rod 39 also serves for filling with the liquefied gas.

The collector 38 comprises, on the second end side, a plug 41 surrounding the rod 39. The plug 41 is made of insulating material. The plug 41 is projecting outwards from the outer envelope 27. The plug 41 may have a prehension zone for demounting, for example for maintenance. The plug 41 has an outer diameter greater than the diameter of the rod 39. The plug 41 forms a sealed head demountable from the cryogenic tank 2.

A stopper assembly comprises the stopper plug 41 and a stopper cap 45. In the case of an airplane or drone type of aircraft, the cryogenic tank 2 may be mounted with the stopper assembly oriented towards the front of the type of aircraft and the free end of the rod 39 towards the rear of the type of aircraft to take advantage of the general inclination of the type of aircraft of several degrees enabling a more complete filling with liquefied gas and a more complete extraction of liquified gas. The cryogenic tank 2 may also be mounted inclined, notably by means of a support member of unequal height between the front and rear of the cryogenic tank 2.

Further, the collector 38 comprises a liquid level gauge 40. The gauge 40 extends along the rod 39. The gauge 40 is connected to the outside of the tank by wire communication passing through the plug 41. The gauge 40 supplies as output a signal representative of the liquid level. The gauge may be capacitive. The precision of the gauge is all the higher when the collector 38 has a small angle with respect to the horizontal. Indeed, for a given resolution of the gauge and a given height of the inner container 26, an increase in length of the inner container 26 enables an increased length of the gauge, thus an enhanced precision. For example, a gauge at 30° with respect to the horizontal has its precision doubled compared to a vertical gauge.

The collector 38 comprises a gas vent 53 for rapid discharge in the event of overpressure. The vent 53 also serves during filling to evacuate the gases to avoid an overpressure. The vent 53 serves during the extraction for a re-pressurisation by introduction of gas if necessary. The vent 53 is arranged in the plug 41 and emerges in the inner container 26 near to the plug 41. The vent 53 is provided with a liquid non-return valve.

The vent 53 is arranged in the plug 41 and emerges in the inner container 26 near to the plug 41. Thus, the vent 53 is connected to the gaseous ceiling of the inner container 26. The vent 53 is connected to a duct passing through the plug 41. A bypass valve with opening pressure lower than the allowable pressure in the cryogenic tank 2 may be connected to the duct. A rupture disk with rupture pressure lower than the allowable pressure in the cryogenic tank 2 may be connected to the duct. The bypass valve and the rupture disk are mounted in parallel.

The collector 38 comprises a temperature sensor arranged in the lower part of the plug 41 on the inner side. The temperature sensor supplies an information of temperature measured in the inner container 26.

The cryogenic tank 26 comprises a thermally insulating neck 42. The neck 42 has a boring. The neck 42 may be made of metal. The metal is selected to be weakly thermally conductive, mechanically resistant, flexible and leak tight to hydrogen. The neck 42 is welded or screwed with a seal to the inner container 26. The neck 42 is welded or screwed with a seal to the outer envelope 27. The neck 42 is sufficiently flexible to accommodate expansion differences between the inner container 26 and the outer envelope 27. The neck 42 comprises an outer wall fastened to the inner container 26 and to the outer envelope 27. The neck 42 comprises an inner wall distant from the inner container 26 and from the outer envelope 27. The inner wall may be fastened to the outer wall at the ends of the neck 42.

The outer wall is tubular. The inner wall is tubular bellows shaped. The inner wall may be made of metal sheet of thickness less than the metal sheet of the outer wall to increase the elastic deformability. The inner wall may have a bellows shape which increases the aptitude to elastic deformation. A bellows shape, for example undulating, decreases the contact surface between the inner wall and the plug 41, hence a low thermal conduction.

Advantageously, the bellows inner wall comprises two concentric sheets. Said sheets are fitted together and connected at the ends. A double wall is thereby formed making it possible to decrease the risk of leakage. In the event of piercing of one of the two sheets, a detection may be made by applying between the two sheets a gas pressure greater than the pressure in the insulation chamber and lower than atmospheric pressure and by monitoring the evolution of the applied pressure. If said applied pressure decreases, the large diameter sheet presents a leak with the insulation chamber. If said applied pressure increases, the small diameter sheet presents a leak with the boring of the neck 42. The neck may then be changed. In addition, if only one of the sheets presents a leak, the insulation chamber conserves its low pressure ensuring weak thermal conduction and the cryogenic tank 2 is operational up to the next maintenance operation. In the case of a single sheet losing its leak tightness, the insulation chamber loses its property of weak thermal conduction and the cryogenic tank 2 is emergency emptied with loss of its contents.

The neck 42 forms a sealed interface between the collector 38 on the one hand and, on the other hand, the outer envelope 27 and the inner container 26. The neck 42 maintains gas tightness between the outer envelope 27 and the inner container 26, whatever the position of the collector 38, or even its absence. The neck 42 is fastened in a sealed manner in a piercing made in the outer envelope 27. The neck 42 is fastened in a sealed manner in a piercing made in the inner container 26. The piercing in the outer envelope 27 and the piercing in the inner container 26 are provided at one of the rounded ends of the cryogenic tank 2 near to the outer diameter of the cryogenic tank 2 in the upper part. The collector 38 extends beyond the neck 42 outwardly by an outer end. The collector 38 extends beyond the neck 42 towards the inside of the cryogenic tank 2 downwards and towards the other of the rounded ends of the cryogenic tank 2.

The neck 42 is formed around a portion of the collector 38. The neck 42 passes through the insulation chamber 29 to enable the collector 38 to be demounted independently of the pressure in the insulation chamber 29. The neck 42 is provided with a through hole 43 in which is installed the plug 41 of the collector 38 in a demountable manner. The contact surface between the neck 42 and the plug 41 may be provided with a female annular teething 44 to increase the length of a leakage path and promote the mechanical holding of the collector 38 in the neck. Here, the teething 44 has chevrons. The plug 41 has in the free state a smooth outer surface of revolution. The plug 41 is adapted to the neck 42. A slight play between the bellows and the plug 41 may be provided. A liquid deflector is provided inside the neck near to the storage chamber 28. The plug 41 is made of thermally insulating material. The plug 41 may comprise a resistant shell and an insulating synthetic foam in the shell.

In the embodiment of FIGS. 6 and 7, the neck is welded to the inner container 26 around its outer wall. The neck 42 has a flange superimposed on a flange of the inner container 26. The welding may be performed by electron beam directed towards the flanges. The neck 42 is welded to the outer envelope 27 around its outer wall at a distance from the weld to the inner container 26. The outer wall of the neck 42 comprises two distinct parts and separated, one connected to the inner container 26 and the other connected to the outer envelope 27.

The inner wall connects the two parts of the outer wall. The inner wall comprises two concentric sheets of thickness comprised between 0.1 and 0.2 mm. Outwardly, the neck 42 comprises a collar 54 directed towards the inner wall. The collar 54 connects in a sealed manner the inner wall and the outer wall. A seal 55 is fastened to the collar 54, notably by screwing. The seal 55 comes into contact with the plug 41 of the collector 38. Here, the level gauge is absent.

The cryogenic tank 2 comprises a cap 45 permanently mounted on the collector 38 and accessible from the outside. The cap 45 is fastened to the rod 39 by screws or bolts. The cap 45 is arranged outside of the outer envelope 27. The cap 45 is arranged at said outer end of the collector 38. The cap 45 is sealed.

The cryogenic tank 2 is provided for a service pressure lower than 8 bars, notably 6 bars.

Advantageously, the cryogenic tank 2 comprises an anti-oscillatory member installed inside the inner container 26. The anti-oscillatory member comprises one or more perforated panels separating the inner volume of the inner container 26 into several zones. The openings of the perforated panels may have a surface area of the order of 1 to 5% of the surface area of the perforated panels. The perforated panels may be longitudinal or transversal. The perforated panels reduced the rate of displacement of the liquefied gas in the inner container 26 during accelerations, for example on take-off, on landing or during atmospheric turbulence.

Advantageously, the cryogenic tank 2 comprises a stiffener inside the inner container 26. The stiffener comprises at least one brace or a tie rod connecting opposite regions of the inner container 26. The stiffener makes it possible to lighten the remainder of the structure of the inner container 26.

In the insulation chamber 29 is installed a hydrogen absorbent material 46, for example a nanoporous material. In the event of slight leak, the loss of insulation linked to the increase in pressure in the insulation chamber 29 is reduced. After such a leak, the outer envelope 27 is demounted to open the insulation chamber 29 and the hydrogen absorbent material 46 is removed to desorb hydrogen, for example by heating.

A hydrogen presence detector 47 is installed in the insulation chamber 29. The presence of hydrogen is monitored. In the event of strong leak, the emergency emptying of the inner container 26 may be commanded. In the event of slight leak, a maintenance operation may be anticipated. The maintenance operation may comprise the repair of the inner container 26 to remedy the leak, the replacement or the desorption of the hydrogen absorbent material, if appropriate, and the evacuation of the insulation chamber 29.

In the embodiment illustrated in FIGS. 1 to 3, the outer envelope 27 comprises two separable parts 48 and 49. A first part 48 comprises an end and a body. A second part 49 comprises an opposite end. The first and the second parts are connected in a sealed manner and separable by two sealing rings 50 and 51 offering metal/metal sealing surfaces through interference. The interference may be cone on cone, torus on cone, or plane on plane with, if appropriate, a shrink fitted metal O-ring—notably of copper alloy—or of elastomer. The interference is ensured by an axial tightening, notably by bolts. The sealing rings 50 and 51 are annular.

In the embodiment illustrated in FIG. 4, the outer envelope 27 is made in several sections. Two sections are connected in a sealed manner by sealing rings 50 and 51 as described above. Sections may be standardised for different capacities of inner container 26 with one end section, one or several central sections, and one end section exempt of piercing for the neck. Several support rings 35 may be provided.

In the embodiment illustrated in FIG. 5, the frame 30 of the outer envelope 27 comprises annular ribs 32, spars 33 parallel to the longitudinal axis and diagonal braces. The outer envelope 27 comprises panels 31 of generally triangular shape, each mounted between a rib, a spar and a brace, and domed panels at the ends. The triangular panels 31 leave the frame 30 apparent. The domed panels cover the frame 30 beyond the ribs 32.

In the embodiment illustrated in FIG. 6, the distribution circuit 1 comprises a first valve 11 for each cryogenic tank 2. The first valve 11 is mounted on the outlet duct 4. The first valves 11 are controlled with an open position and a closed position. The intermediate positions of the first valves 11 are dynamic in the sense that the first valves 11 are in movement while passing into said intermediate positions. In other words, the first valves 11 are all-or-nothing valves. The first valves 11 may be arranged immediately downstream of the flow meters 22.

The first valves emerge in a cryogenic distributor 5. The cryogenic distributor 5 may comprise a common duct 6 connecting the outlets of the first valves 11. The distributor is cryogenic in the sense that it has liquid fuel/oxidant passing through.

The cryogenic distributor 5 comprises a plurality of outlets, here three. On each of said outlets are mounted two second valves 12. The second valves 12 are controlled with an open position and a closed position. The intermediate positions of the two valves 12 are dynamic in the sense that the second valves 12 are in movement while passing into said intermediate positions. In other words, the second valves 12 are all-or-nothing valves. The second valves 12 are here three in number.

Downstream of each second valve 12 a central tank 7 is mounted. Three central tanks 7 are provided in this embodiment. Each central tank 7 also serves as gasifier. An insulation may be provided. Each central tank 7 receives liquid and supplies gas downstream. A rise in pressure or gasification step occurs in each central tank 7 between the filling and the emptying. Each central tank 7 is capable of withstanding a maximum service pressure of the order of 300 to 1000 bars. Each central tank 7 is designed to operate in a temperature range extending from −253° C. to +60° C. The central tanks 7 are biphase on one part of the operating steps and gaseous monophase on the other operating steps. Each central tank 7 may be equipped with a heating member 8.

Downstream of each central tank 7 is installed a third valve 13 to supply gas and a pressure reducer 9 downstream of the third valve 13. The pressure reducer 9 clips the pressure to supply gas at a consumption pressure set by the manufacturer of the consuming member 3. The pressure reducer 9 is active when the pressure in the central tank 7 is greater than the consumption pressure and inactive otherwise. The consumption pressure is lower than the maximum pressure of the central tank 7. The consumption pressure is independent of the maximum pressure of the cryogenic tanks. The third valves 13 are all-or-nothing valves.

Downstream of each pressure reducer 9 may be provided a fourth commanded valve 14. The fourth valves 14 are all-or-nothing valves.

The fourth valves 14 or the pressure reducers 9, depending on the chosen option, emerge in a collector 10. The collector 10 may comprise a duct connecting the outlets of the fourth valves 14 or the pressure reducers 9. Gas passes through the collector 10. The collector 10 is connected downstream to supply ducts 23 to the consuming members 3. In general, a supply duct 23 is provided for each consuming member 3. Each supply duct 23 may be equipped with a controlled supply valve 24. The supply valve 24 is variable flow rate.

The distribution circuit comprises at least one compressor 20 connected to the collector 10. In general, two compressors 20 are provided in parallel for redundancy. The compressor 20 is electric. The compressor 20 may be equipped with a controlled upstream valve. The compressor 20 delivers gas into the collector 10. In particular, the collector 10 is constituted of a duct in the event of single consuming member 3.

Downstream of each central tank 7 is installed a fifth valve 15 to supply gas and a second collector 38 downstream of the fifth valves 15. The second collector 38 is connected to the compressor 20. The fifth valves 15 make it possible to insulate the central tanks 7 and the compressor 20. The fifth valves 15 are commanded. The fifth valves 15 are all-or-nothing valves.

The compressor 20 increases the pressure to supply gas at a pressure equal to a consumption pressure set by the manufacturer of the consuming member 3. The consumption pressure is lower than the maximum pressure in the central tank 7. The compressor 20 makes it possible to withdraw gas in the central tank 7 in which the pressure is lower than the consumption pressure to supply the collector 10 and the consuming members 3. A more complete emptying of the central tank 7 makes it possible to increase the autonomy provided by the gas contained in a central tank 7 or to reduce the volume of the central tank 7.

A sufficient emptying of the central tank 7 to bring the internal pressure of the central tank 7 to a value lower than the pressure in one of the cryogenic tanks makes it possible, during the filling succeeding the emptying, to transfer the liquid from the cryogenic tank to the central tank 7 by pressure difference. Thus, the liquid of the cryogenic tank is sucked up by the central tank 7 until pressure equilibrium. It is possible to do without a cryogenic pump, hence a gain in mass and energy consumed.

The distribution circuit 1 offers a combination of individual states of each cryogenic tank, of each central tank 7 and of each consuming member 3. Several consuming members 3 may be active simultaneously. In normal mode, a cryogenic tank is in the course of emptying while the others are inactive thus closed. However, in certain situations, for example to decrease the pressure in several cryogenic tanks, a particular mode may be provided wherein several cryogenic tanks are in the course of emptying. The central tanks 7 have a filling mode, a gasification mode, a gas storage mode and an emptying mode.

When one of the cryogenic tanks is in emptying mode, the corresponding first valve 11 is open and the other first valves 11 are closed. When one of the consuming members 3 is in the course of being supplied, the corresponding supply valve 24 is open.

When one of the central tanks 7 is in filling mode, the second valve 12 connected to said central tank 7 is open and at least one of the first valves 11 is open. The other second valves 12 are closed except in the case where a simultaneous filling of two central tanks 7 is performed. The third valve 13 connected to said central tank 7 is closed. The fifth valve connected to said central tank 7 is closed.

When one of the central tanks 7 is in gasification mode, the second valve 12 connected to said central tank 7, the third valve 13 connected to said central tank 7 and the fifth valve 15 connected to said central tank 7 are closed. The gasification mode is of short duration, in particular in the case of hot ambient atmosphere and/or heating of the central tank 7.

When one of the central tanks 7 is in emptying mode, the second valve 12 connected to said central tank 7 is closed. In the first emptying part, the pressure in the central tank 7 is greater than the consumption pressure. The third valve 13 connected to said central tank 7 is open, the corresponding fourth valve 14 is open and the fifth valve connected to said central tank 7 is closed. The gas undergoes a pressure reduction in the pressure reducer 9 and is supplied to the collector 10 at the consumption pressure. The gas is next consumed by the consuming member(s) 3.

At a given instant, among three central tanks 7, one is in filling mode, another in gasification then storage mode and the third in emptying mode. Since the modes have different durations, it is thus possible to have two central tanks 7 in filling mode and the third in emptying mode or vice versa. It is also possible to have two central tanks 7 in storage mode and the third in emptying mode or vice versa.

In the embodiment, a flow meter 22 is arranged at the outlet of each source of liquid fuel/oxidant 2. The flow meters 22 make it possible to know, with sufficient precision, the amount of liquid supplied to such a central tank 7.

In one embodiment, the distribution circuit 1 comprises a command unit 25 receiving an external instruction for example coming from the consumer organs 3 external to the aeronautical storage device or a central command unit of the aircraft, and liquid flow rate data coming from the flow meters 22. The command unit 25 generates and sends instructions to said first, second, third, fourth and fifth commanded valves and to the commanded supply valves 24. The instructions may be “open” or “closed”. The command unit 25 manages said combination of individual states.

In an alternative, the first valves 11 may be replaced by at least one multiport valve having several inlets and an outlet. In this case, it is interesting to provide a multiport valve with mixed positions, notably at least one position of simultaneous emptying of two or more cryogenic tanks 2 to reduce the pressure therein while avoiding a loss in the atmosphere.

In an alternative, the second valves 12 may be replaced by at least one multiport valve having an inlet and several outlets, one per central tank 7. Said multiport valves form a distributor.

In an alternative, the pressure reducers 9 are replaced by a single pressure reducer 9, the third valves 13 emerging in the single pressure reducer 9. In this case, the third valves 13 may be replaced by at least one multiport valve having several inlets and an outlet to the pressure reducer. The fourth valves 14 are then replaced by a single fourth valve 14, if appropriate not controlled.

In an alternative, the fifth valves 15 may be replaced by at least one multiport valve having several inlets, one per central tank 7, and an outlet to the compressor 20 or the compressors 20. Said multiport valve forms a collector 10.

The cryogenic tanks 2 being subject to evaporation from the liquid, a gas collection circuit may be provided in the upper part of the cryogenic tanks 2. The collection circuit may be active above a threshold pressure by a calibrated pressure bypass valve. The collection circuit comprises an injector to reinject the gas downstream, for example between the fifth valves 15 and the compressor 20.

Optionally, additional flow meters are arranged at the inlet of each buffer tank. A redundancy of liquid flow rate measurement is ensured.

The capacity of the cryogenic tank device is comprised between 10 kg and 10,000 kg of gas, preferably between 100 kg and 10,000 kg of gas.

A temporary storage and gasification tank 7 is provided for the pressurisation of the gas supplied by the device. An upstream valve 12 is provided to be open for liquid flow during a filling phase of the temporary storage tank 7 and closed during the emptying phase. At least one downstream valve 13,15 is provided to be open for gas flow during an emptying phase of the temporary storage tank 7 and closed outside of the emptying phase. The upstream valve and the downstream valve are closed during a gasification phase. The upstream valve and the downstream valve are all-or-nothing commanded. At least one compressor 20 is arranged downstream of the downstream valve 15. The compressor 20 is active at the end of the emptying phase to bring the pressure in the temporary storage tank 7 to a value lower than the value of the pressure in the device. A pressure reducer 9 is arranged downstream of the downstream valve. The pressure reducer 9 is active at the beginning of the emptying phase to bring the pressure of the gas at the outlet to a value lower than the pressure in the temporary storage tank 7.

The rail, road or maritime gas storage cryogenic tank device, of spherical or elongated shape, notably around a longitudinal axis, comprises an inner container defining a liquefied gas storage chamber 28, an outer envelope 27 containing the inner container and made of a plurality of demountable parts making it possible to access the inner container, the outer envelope 27 being made of a material resistant to temperatures from less than −60° C. to at least +80° C., an insulation chamber 29 defined between the inner container and the outer envelope, the reduced-pressure insulation chamber 29 having helium-tightness equal to or better than 10⁻⁹ millibar*litre/second defined between the inner container and the outer envelope, two connections of which at least one is a sliding connection, supporting the inner container and borne by the outer envelope, a support ring mounted between the inner tank and the outer envelope at a distance from the connections in the insulation chamber, a removable collector 38 passing through the outer envelope and the inner container in a sealed manner, and a flexible thermally insulating neck 42 forming a sealed interface between the collector 38 on the one hand and, on the other hand, the outer envelope and the inner container, the neck 42 being formed around a portion of the collector 38, the neck 42 passing through the insulation chamber in order to allow the collector 38 to be demounted independently of the pressure in the insulation chamber.

The storage and distribution assembly comprises a hydrogen storage cryogenic tank device, comprising an inner container defining a liquefied gas storage chamber, an outer envelope containing the inner container, a sealed insulation chamber defined between the inner container and the outer envelope, a removable liquefied gas collector passing through the outer envelope and the inner container in a sealed manner, the collector extending over a diameter or a diagonal of the inner container and having a free end close to a bottom of the inner container, a liquefied gas duct supplied by the collector, a temporary storage tank forming a gasification member for the pressurisation of the gas supplied by the device, an upstream valve provided to be open for liquid flow during a filling phase of the temporary storage tank and closed during the emptying phase, a downstream valve provided to be open for gas flow during an emptying phase of the temporary storage tank and closed outside of the emptying phase, the upstream valve and the downstream valve being all-or-nothing commanded, and a pressure reducer arranged downstream of the downstream valve, said pressure reducer being active at the beginning of the emptying phase to bring the pressure of the gas at the outlet to a value lower than the pressure in the temporary storage tank.

1. An on-board aeronautical gas storage cryogenic tank device, of spherical or elongated shape, comprising an inner container defining a liquefied gas storage chamber, an outer envelope containing the inner container and made of a plurality of demountable parts making it possible to access the inner container, the outer envelope being made of a material resistant to temperatures from less than −60° C. to at least +80° C., an insulation chamber defined between the inner container and the outer envelope, the insulation chamber having helium-tightness equal to or better than 10-9 millibar*litre/second defined between the inner container and the outer envelope, two connections of which at least one is a sliding connection, supporting the inner container and borne by the other envelope, a removable collector passing through the outer envelope and the inner container in a sealed manner, and a flexible thermally insulating neck forming a sealed interface between the collector on the one hand and, on the other hand, the outer envelope and the inner container, the neck being formed around a portion of the collector, the neck passing through the insulation chamber in order to allow the collector to be demounted independently of the pressure in the insulation chamber.

2. The device according to claim 1, comprising a thermally insulating stopper assembly removably mounted on the collector and accessible from the outside.

3. The device according to claim 1, wherein one of the connections comprises an axial concavity in the outer envelope receiving and supporting an axial projection of the inner container.

4. The device according to claim 1, wherein the outer envelope comprises a frame, sealed panels, seals resistant to the pressure between the frame and the panels or between the panels.

5. The device according to claim 4, wherein the frame comprises ribs and spars.

6. The device according to claim 4, wherein the seals are housed in grooves and, in the free state, go beyond the grooves by a height less than 10% of a height of said seals.

7. The device according to claim 1, comprising an anti-oscillatory member inside the inner container and a stiffener inside the inner container.

8. The device according to claim 1, comprising at least one support ring mounted between the inner container and the outer envelope at a distance from the connections in the insulation chamber.

9. The device according to claim 1, wherein a hydrogen absorbent material is arranged in the insulation chamber and a hydrogen presence detector is installed in the insulation chamber.

10. An assembly comprising a device according to claim 1, a temporary storage tank forming a gasification member for the pressurization of the gas supplied by the device, an upstream valve provided to be open for liquid flow during a phase of filling the temporary storage tank and closed outside of the filling phase, a downstream valve being provided to be open for gas flow during a phase of emptying the temporary storage tank and closed outside of the emptying phase, the upstream valve and the downstream valve being closed during a gasification phase, the upstream valve and the downstream valve being all-or-nothing commanded, and a compressor arranged downstream of the downstream valve, said compressor being active at the end of the emptying phase to bring the pressure in the temporary storage tank to a value lower than the value of the pressure in the device, and a pressure reducer arranged downstream of the downstream valve, said pressure reducer being active at the start of the emptying phase to bring the pressure of the gas at the outlet to a value lower than the pressure in the temporary storage tank (7).

11. The device according to claim 1, wherein the outer envelope comprises a frame, sealed panels, seals resistant to the pressure between the frame and the panels and between the panels.

12. The device according to claim 5, wherein the seals are housed in grooves and, in the free state, go beyond the grooves by a height less than 10% of a height of said seals.

13. The device according to claim 1, comprising an anti-oscillatory member inside the inner container and a stiffener inside the inner container, wherein the anti-oscillatory member comprises a brace or a tie rod.
